(19) United States
(12) Patent Application Publication
(10) Pub. No.: US 2013/0005363 A1
(43) Pub. Date: Jan. 3, 2013

(54) Predictive Notification System for Emergency Services

(76) Inventor: Walter Scott Tester, San Francisco, CA (US)

(21) Appl. No.: 13/615,453

(22) Filed: Sep. 13, 2012

Related U.S. Application Data
(63) Continuation of application No. 12/317,596, filed on Dec. 22, 2008.

(51) Int. Cl. H04W 68/00; H04W 8/02; H04W 4/02

(52) U.S. Cl. 455/456.3

(57) ABSTRACT

A predictive notification system identifies certain mobile devices in a wireless telecommunications network that are likely to be within a predetermined geographical area of interest during a predetermined period of time. The identified location/time pair may be one that is associated with or affected by a particular event (e.g., emergency, construction, disaster, traffic, weather or other alerts and events). This allows a notification (about the event) to be sent to the identified mobile devices in an effort to notify them of the event prior to entering the affected area. A trending profile generated and maintained for each mobile device in the network is examined/consulted to determine the identity of those mobile devices that are likely to be within the affected area during the relevant time period.

### TECHNICAL FIELD

The present invention relates generally to telecommunication systems, and more particularly, to methods and systems for providing notification(s) of an emergency to users.

### BACKGROUND

When a disaster strikes or an emergency situation occurs, it is difficult to quickly notify those people who may be affected, especially for those who are unable to, or who do not, receive media coverage of the event.

Other methods and systems have been, or are currently being, deployed to provide an event notification to predetermined users. One prior art system requires users to preregister (for instance, on a website) and provide the mobile phone number and the specific area (e.g., zip code/codes) about which the user is interested in receiving notifications. This technique works well where it is possible to preregister all users, but it has two major shortcomings. Some users will not take the time to register with this service since some people do not presume a disaster will happen that affects them until it does and others simply will not take the time and effort to register. In addition, users are required to list all the zip codes where they will likely be present, including areas in which they will be traveling through. This is not practical as people often may not even know the correct information regarding the areas of interest and, over time, it may likely change. While, theoretically, a proactive user may have thought to register all areas of interest, certain areas in which the person might only travel through may not be identified. Furthermore, this approach fails does not take into account the concept of time. Notifications are sent to all registered users who have identified a particular zone (zip codes) regardless of time (hour/time of day, day of week, etc).

Another solution is called a reverse 911 approach. Basically, when a disaster strikes or other event occurs, notifications are sent out to all phones registered within a certain geographical area (such as land-based phones and mobile phones specifically registered to be in the area). In the wireless domain, a phone call or SMS text message can be sent to all mobile phones currently located within the geographical area serviced by a certain cluster/group of base stations or towers. This may work effectively to notify people that a disaster has occurred in the geographical area where they are located right now. However, this approach does not work for people who are traveling to that geographical location (outside the group of base stations) or who may be traveling there in the near future. Reliance on media coverage or police blockades may be useful for long running events, such as ongoing wildfires in California, but these notification systems are unreliable (and may not even occur) for sudden/unexpected disasters such as a terrorist attack or gas main break.

Accordingly, there is a need for a method and system for identifying people not currently in an area of interest (an area in which an emergency or event has or is occurring), but who are expected to move or travel to that area of interest in the near future.

### SUMMARY

In accordance with one embodiment, there is provided a method for, in response to detection of an event that may affect a predetermined geographical area of interest, transmitting a notification message to one or more mobile devices in a wireless telecommunications network. The method includes receiving location information associated with an event in which the location information is operable for identifying a predetermined geographical area of interest. Trending profiles associated with each one of a plurality of mobile devices within a telecommunications network is examined, and from the trending profiles for each one of the plurality of mobile devices, a probability that the mobile device will be in the predetermined geographical area of interest in the future is determined. A list is generated and stored in memory within a device coupled to the telecommunications network, where the list includes mobile device identifiers for each mobile device having its determined probability above a predetermined probability threshold.

In accordance with another embodiment, there is provided a method for identifying one or more mobile devices in a wireless telecommunications network likely to be within a predetermined geographical area of interest during a predetermined time period. The method includes receiving location information and predetermined time period information, the location information operable for identifying the predetermined geographical area of interest; processing a respective trending profile associated with each one of a plurality of mobile devices within the telecommunications network to determine, for each one of the plurality of mobile devices, a probability that the mobile device will be in the predetermined geographical area of interest during the predetermined time period; and if the determined probability of the respective mobile device meets a predetermined probability, the mobile device is identified as one that is likely to be within a predetermined geographical area of interest during the predetermined time period.

In yet another embodiment, there is provided a predictive notification processing system for use in identifying and notifying mobile devices in a wireless telecommunications network that are likely to be within a predetermined geographical area of interest during a predetermined time period. The predictive processing system includes a processor, memory coupled to the processor, and a network interface coupled to the processor and operable for communicating with a telecommunications network. The processor is operable to: receive location information associated with an event and predetermined time period information, the location information operable for identifying a predetermined geographical area of interest, access and examine a trending profile associated with each one of a plurality of mobile devices within a telecommunications network, determine from the trending profiles, for each one of the plurality of mobile devices, a probability that the mobile device will be in the predetermined geographical area of interest during the predetermined time period, and generate and store in the memory a list including mobile device identifiers for each mobile device having its determined probability above a predetermined probability threshold.

Other technical features may be readily apparent to one skilled in the art from the following figures, descriptions, and claims.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 depicts a high level diagram of one embodiment of an example telecommunications system in accordance with the present disclosure;

FIG. 2 is a block diagram illustrating the predictive notification processing system shown in FIG. 1; and

FIG. 3 illustrates one embodiment of a process flow or method for identifying a number of UEs not currently in a predetermined area of interest but are expected to be in the predetermined area of interest in the immediate or near future.

### DETAILED DESCRIPTION

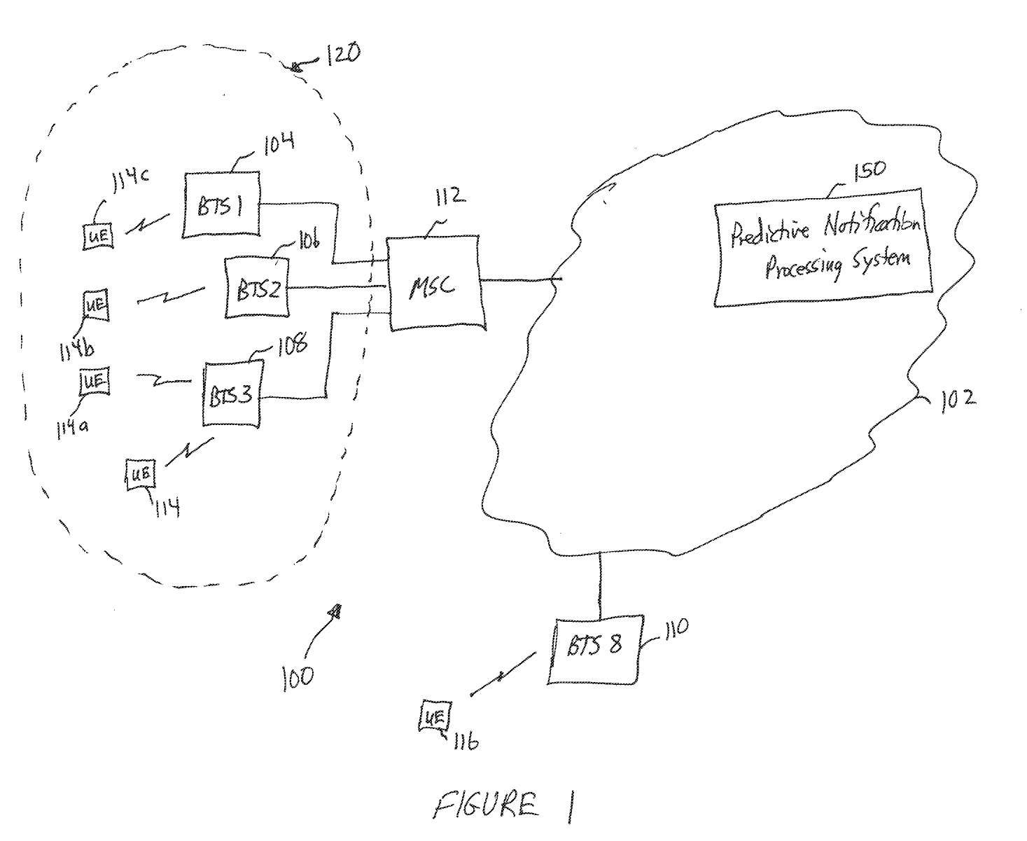

FIG. 1 illustrates an example communications network architecture or system 100 in accordance with the present disclosure. The system or network 100 shown in FIG. 1 is for illustration purposes only, and represents a cell or sector. Other embodiments of the system 100 may be used without departing from the scope of this disclosure. In the event of a reference to “standards” or “specifications” in the text, this is meant to encompass existing and future versions of the referenced standards or specifications, as well as standards or specifications encompassing the principles of the subject matter disclosed and claimed herein.

In this example, the system 100 is part of (or communicates with) a larger communication services network 102, and the system 100 includes a plurality of base stations, identified by reference numerals 104 (BTS1), 106 (BST2), 108 (BTS3), and 110 (BTS8) which are capable of communicating wirelessly with one or more user equipment stations (UE) within the base station coverage area. Associated with the base stations 104, 106 and 108 is a mobile switching center (MSC) 112. As shown, the base stations 104, 106 and 108 form a cluster or group and provide telecommunications services to UEs located within an area of interest 120. In the example shown, a UE 114 is located within the area of interest 120, while UE 116 is positioned outside the area of interest. The area of interest 120 may coincide with all or a portion of a single base station's coverage area, all or a portion of a group/cluster of base stations' coverage area, all or portions of multiple groups/clusters of base stations, and may be any relative size or configuration, as desired. The area of interest is usually the area determined to be affected by, or relevant to, an emergency, disaster or other event. It will also be understood that multiple areas of interest (only one shown) may exist.

In one embodiment, the access services network (not shown) and system 100 (or portions thereof) is a wireless communications network compliant or operating in accordance with one or more standards or specifications, such as a 2G, 3G or 4G standard or specification, and/or other communications protocols. Though only four BTSs 104, 106, 108 and 110, one MSC 112, and two UEs 114, 116 are shown, the system 100 may include additional BTSs, MSCs, and UE stations, and other devices (not shown). For example, there may be multiple MSCs 112 per area of interest 120, and in one embodiment, no MSCs 112 may exist (i.e., BTSs communicating directly with the cloud network 102). Each of the BTSs and UEs generally include one or more antennas and various hardware and software components.

The network 102 may include one or more local area networks (“LAN”), metropolitan area networks (“MAN”), wide area networks (“WAN”), all or portions of a global network, or any other communication system or systems at one or more locations, or combination of these, including the public switched telephone network (PSTN), Internet, packet networks and the like. The network typically also includes a BTS backhaul network (not shown) which is a data network utilized for communications between the BTSs and mobile switching centers (MSCs) and/or gateways. These networks may be configured to include Internet, packet networks and the like.

Other components, devices or networks may be included in the system 100 (and network 102), and FIG. 1 only illustrates but one exemplary configuration to assist in describing the system and operation of the present disclosure to those skilled in the art. The system represented in FIG. 1 may be described using different nomenclature or system terminology, such as use of the terms user equipment (UE), access terminal (AT) or mobile subscriber terminals (MS or MT), and base station or base transceiver station (BTS) or access points, and mobile switching center (MSC). The use of any given nomenclature to describe a device within the system 100 is not intended to limit the scope of this disclosure.

One or more of the BTSs 104, 106, 108 has coupled thereto at least one UE 114 (several shown). Outside the area of interest 120, the BTS 110 has coupled thereto the UE 116. The UEs are operable for communicating wirelessly with a BTS over an air interface.

The structure and functionality of a conventional BTS and a conventional MSC are generally well-known. A conventional BTS and MSC generally include various components such as processing units, controllers and network interfaces, which necessarily include but are not limited to, microprocessors, microcontrollers, memory devices, and/or logic circuitry, and these may be adapted to implement various algorithms and/or protocols. No additional description of the conventional components and software processes (functionality) of a BTS or MSC, other than as noted herein or relevant for an understanding of the present disclosure, is provided, as these are known to those of ordinary skill in the art. It will be understood that the BTSs and MSC may be constructed or configured from any suitable hardware, software, firmware, or combination thereof for providing the functionality known to those of ordinary skill in the art. Either or both of the BTSs 104, 106, 108, 110 and the MSC 114 will include additional functionality as described below in accordance with one or more embodiments.

The UEs 114, 116 represent devices utilized by a user or subscriber during communication sessions over/within the system 100. The UEs typically include a processor, memory, a transceiver and an antenna and may be constructed or configured from any suitable hardware, software, firmware, or combination thereof for transmitting or receiving information over a network. These devices may further include an input/output device having a microphone and speaker to capture and play audio information, as well as a camera and/or a display to capture/display video information. As an example, the UEs may be a telephone, videophone, computer, personal digital assistant, GPS device, and the like, or other devices intended to receive/transmit wirelessly to base stations or access points. In one embodiment, the UEs are mobile devices and travel from one area to another. No additional description of the conventional components and software processes (functionality) of the UEs 114, 116, other than as noted herein or relevant for an understanding of the present disclosure, is provided, as these are known to those of ordinary skill in the art. It will be understood that the UEs 114, 116 may be constructed or configured from any suitable hardware, software, firmware, or combination thereof for providing the functionality known to those of ordinary skill in the art.

In general terms, the present disclosure describes systems and methods for monitoring UE activity and movement within the network 102 (through different BTS coverage areas) and generating a trending profile for each UE. Information in the trending profile can be used to predict anticipated locations of the UEs and identify which UEs are more likely to be within a predetermined area of interest and at which times they would likely be there. This allows for notifications of events (e.g., emergency, construction, disaster, traffic, weather or other alerts, and even possibly advertising) associated with a predetermined area of interest to be transmitted to those UEs identified as likely to be in the area of interest at a relevant time. Thus, certain UEs which are identified using trending profile information and may not presently be within the area of interest are targeted to receive the event notification(s). It will be appreciated that UEs presently in the area when the event occurs are easily identifiable. In one embodiment, the system receives a predetermined location (area of interest) and time frame, such as resulting from an event alarm activated by emergency or other governmental services for a certain geographical area(s). In response, a group of UEs likely to be in the noted area of interest at some point within the noted time frame is identified. Once identified, some action may be taken, e.g., sending notifications to inform the UEs about the event and/or the area.

With continued reference to FIG. 1, the system 100 further includes a predictive notification processing system 150, such as an application operating on a device or appliance within the network 102 or within a dedicated server/computer coupled to the network 102. System 150 is configured to receive activity information for each UE within the network 102. This activity information is typically generated as part of the conventional information recorded within the network 102 during actual communication sessions (e.g., voice or data call sessions) or roaming/status events (e.g., UE pings to/from base stations). The activity information may include different types of information recorded during communication sessions, and may typically include UE identification number (e.g., phone, IP address or EIN), time information (e.g., month, day, time) and position/location information. The position/location information may be as simple as the BTS identification information, or could be a mapping location or coordinates of the coverage area or similar area associated with the BTS. Throughout this description, it will be understood that an identification of a particular BTS may be mapped to physical coordinates or areas, and vice versa.

In one embodiment, existing BTSs and/or accounting, maintenance and administration record generation systems (within the BTSs, MSCs or other devices in the network) are configured to transmit or otherwise send the UEs activity information (ping/call data) to the predictive notification processing system 150. In another embodiment, this information may be mined or otherwise requested from billing/accounting records conventionally recorded as a result of the UE communication sessions.

For each UE, the received UE-specific activity information is utilized to generate a trending profile. The trending profile may be updated continuously or periodically, as desired. Any suitable methods and/or devices may be used to generate the trending profiles, and it is believed that a person of ordinary skill in the art will be able to utilize existing trending profile methods and software or develop such methods and software. In one embodiment, the predictive notification processing system 150 generates the UE trending profiles.

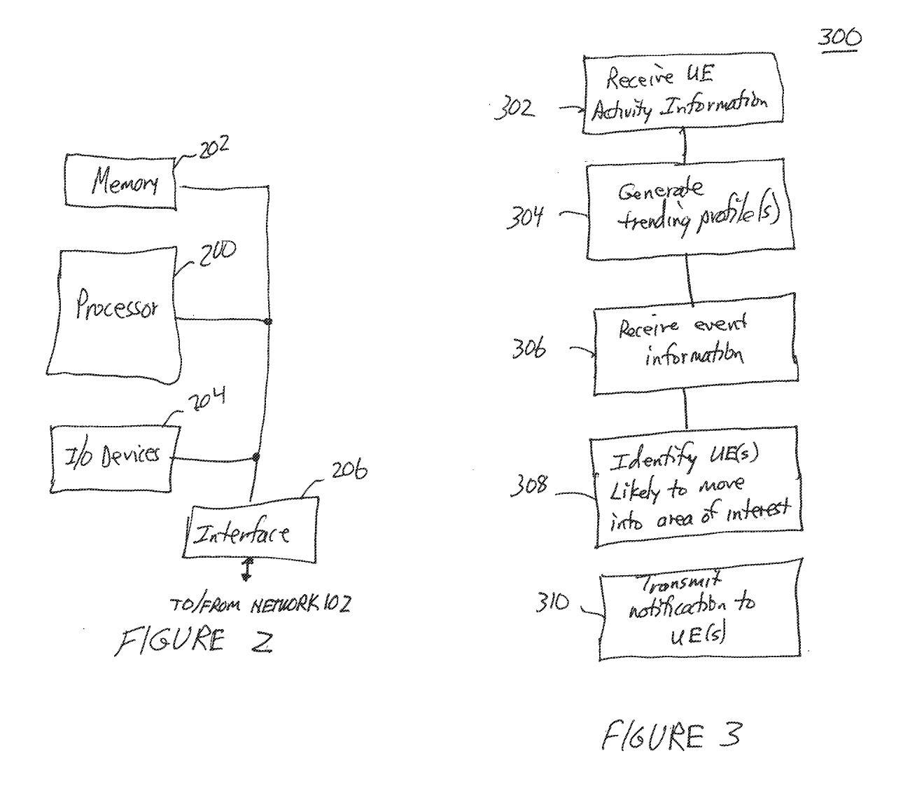

Now turning to FIG. 2, there is shown a block diagram of one embodiment of the predictive notification processing system 150 in accordance with the present disclosure. The predictive notification system includes a processor (which may include a digital signal processor) 200, memory 202, and various input/output devices 204. Other components and circuitry may be included, but are not shown. Details of the operation and structure of these components, except as necessary to illustrate the operations and methods described herein, have been omitted. The system 150 also includes a network interface 206 for communicating (wireline or wireless) with the network 102.

It will be understood that the functions and processes (as described herein) of the predictive notification processing system 150 may be distributed across multiple devices (not shown) or centrally performed on a single device (and the depiction of the system 150 in FIG. 1 may be either logical or physical). Furthermore, the system 150 may constitute an application executing on a computing device (and the computing device will likely include the elements shown in FIG. 2).

Memory 202 (internally or externally located) stores the UE trending profiles for each UE. This may be in the form of a database storing a list of UE identifiers with each one having an associated trending profile. In one embodiment, each trending profile includes position/location information and time information. The trending profile can be conceptually identified as a set of all location points for a given entity plotted against time and probability. For instance, there may be a 95% probability that a given UE would be in a certain geographical area on Tuesday at 10 am and an 85% probability that the UE would be in that area on Tuesday at 5 pm. Every UE has its own trending profile. Each trending profile may have multiple probabilities, one probability for each locale (e.g., 85% for locale #1; 10% for locale #2, etc.). In one embodiment, probabilities around zero (or below a certain threshold) may simply be omitted from the profile. The more data gathered (and over a greater length of time), the more accurate the probability for any location/time pair for a given UE. In addition, the more consistent a UE is in its movements, the higher the probability will be. Multiple probabilities, one for each locale, may be The trending profile may further include multiple

Operation of the predictive notification processing system 150 within the system 100 (for an understanding of the present disclosure) will now be described. As a general description, the communication devices 114, 116 are operable for communicating with a respective BTS 104, 106, 108, 110 and for establishing or initiating a communication session or call between the devices in the system 100.

Turning to FIG. 3 (and with continued reference to FIG. 1), there is illustrated one embodiment of a process flow or method 300 including identifying a number of UEs (users) that are not currently in a predetermined area of interest but are expected to be in the predetermined area of interest in the immediate or near future (e.g., a predetermined time period), and for sending them a notification.

Within the network 102, and in one embodiment, the predictive notification processing system 150 receives UE activity information for all or a portion of the active UEs 114, 116 within the network 102 (step 302). As described previously, the UEs activity information may be conventional call session tracking information for billing and accounting purposes, specific call session data and/or recordable ping/status information, generated by the BTSs or MSCs and typically forwarded to another device(s) and stored in the network 102. This UE activity information may be received from the BTSs, MSCs and or other device(s), and received periodically or when activity information is generated.

After receiving UE activity information from one of the UEs, it is processed with any available stored past UE activity information for that UE to generate (or enhance/update) a trending profile (step 304). As will be understood, this process occurs for every UE within the network 102 (or within a geographical portion of the network). This process may occur periodically or substantially continuously (every time new UE activity information is received for a given UE). Though not shown in FIG. 3, the step 302 and/or 304 may have additional paths/arrows that lead out of step 302 and back into step 302, lead out of step 304 and back into either step 302 or 304. This illustrate that the steps 302, 304 are continuously/periodically being performed.

Upon determining that an event has occurred or will occur and will affect a predetermined geographical area of interest for a predetermined period of time, the predictive notification processing system 150 receives information that identifies a predetermined area of interest and period of time (step 306). Various facts about the determination (e.g., who, how, why, area of interest, period of time) that an event has or will occur has been omitted. This may be determined in any suitable manner by various individuals and/or entities.

For each UE, a probability that the UE will be in the predetermined geographical area during the predetermined time period is calculated or determined. For those UEs whose having a probability exceeding a predetermined threshold, these UEs are identified (and stored in a list) as UEs that are likely to move into the geographical area during the relevant time period (step 308). The identity of the identified UEs may be supplied to a messaging system which sends notifications (or notification messages) to each UE identified in the list (step 310). The notifications provide some information (e.g., warning, instructions, etc.) about the event. A notification may take any form, such as a notification call (similar to reverse 911) and/or an SMS message. These notifications may be sent to all UEs in the list, or just to those identified UEs whose current position is not within the predetermined geographical area of interest. In another embodiment, it may possible that, for those UEs located within the area of interest at the time of event determination, notifications may be sent to them (e.g., broadcast) without examining their trending profiles (since they are presently in the area). In another embodiment, notifications, may be sent to both the set of UEs identified as likely. (expected) to be in the area of interest (during the relevant time period) combined with the set of UEs currently active (ongoing communications, status transmissions, such as pinging the base station(s)) in the area of interest.

To help illustrate the present disclosure, the following example is provided (and reference should be made to FIG. 1).

Let us assume that each UE 114, 116 has a trending profile already generated and stored within the network 102 and accessible by the predictive notification processing system 150. Also, the trending profile associated with UE 116 indicates that the UE 116 will likely travel to the area of interest 150 during the day (10 am to 7 pm) (this information is determined by the trending profile process using reported activity information of the UE 116).

Further assume that a gas main has broken at 9 am in the area of interest 150, an “event” has been detected or determined, the area of interest is identified, and the period of time necessary to evacuate and repair the gas main is determined to be indefinite. This information (area of interest, time period—9 am to ?) is transmitted to and received at the predictive notification processing system 150. In response, the system 150 calculates or determines the probabilities for various UEs in the network 102. The probability that UE 116 will be in the area of interest 150 during the time period is relatively high (and exceeds a threshold). Based on this, the system 150 causes a notification to be sent to the UE 115 about the determined event. This allows for warnings or notifications to be sent to UEs not currently in the area of interest 150 but which have a likelihood that they will be in the area of interest 150 in the imminent or near future (at least during the identified time period).

Different carriers may utilize different networks and have different subscribers (UEs). In this event, it is possible that only UEs for one carrier may be notified. To facilitate notifications to all UEs, all carriers should include a system that implements the teachings and concepts of the present disclosure. In another embodiment, information sharing between carriers and provisioning of a central and global repository or list of all UEs (and their associated trending profiles) may be implemented and accessible by all carriers.

In some embodiments, some or all of the functions or processes of one or more of the devices are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory.

It may be advantageous to set forth definitions of certain words and phrases used throughout this patent document. The terms “include” and “comprise,” as well as derivatives thereof, mean inclusion without limitation. The term “or” is inclusive, meaning and/or. The phrases “associated with” and “associated therewith,” as well as derivatives thereof, mean to include, be included within, interconnect with, contain, be contained within, connect to or with, couple to or with, be communicable with, cooperate with, interleave, juxtapose, be proximate to, be bound to or with, have, have a property of, or the like.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without. departing from the spirit and scope of this disclosure, as defined by the following claims.

What is claimed is:

1. A method for, in response to detection of an event that may affect a predetermined geographical area of interest, transmitting a notification message to one or more mobile devices in a wireless telecommunications network, the method comprising:
receiving location information associated with an event, the location information operable for identifying a predetermined geographical area of interest;
examining a trending profile associated with each one of a plurality of mobile devices within a telecommunications network;
determining from the trending profiles, for each one of the plurality of mobile devices, a probability that the mobile device will be in the predetermined geographical area of interest in the future; and
generating and storing in memory within a device coupled to the telecommunications network a list including mobile device identifiers for each mobile device having its determined probability above a predetermined probability threshold.

2. The method in accordance with claim 1 further comprising:
sending a notification message to each mobile device in the list.

3. The method in accordance with claim 1 further comprising:
receiving time information, the time information operable for identifying a period of time; and
wherein determining the probability further includes determining the probability that the mobile device will be in the predetermined geographical area of interest during the period of time.

4. The method in accordance with claim 3 further comprising:
sending a notification message to each mobile device in the list.

5. The method in accordance with claim 1 further comprising:
storing the trending profiles in memory within one or more devices coupled to the telecommunications network.

6. The method in accordance with claim 5 further comprising:
generating the trending profiles using activity information generated in response to one or more mobile device activities involving the mobile device in the telecommunication network.

7. The method in accordance with claim 6 wherein the one or more mobile device activities include a call associated with the mobile device.

8. The method in accordance with claim 7 wherein the one or more mobile device activities include a roaming/status event associated with the mobile device.

9. The method in accordance with claim 6 wherein the activity information for a mobile device activity comprises a mobile device identifier, a time period, and position/location information capable of identifying a geographic position/location of the mobile device.

10. A method for identifying one or more mobile devices in a wireless telecommunications network likely to be within a predetermined geographical area of interest during a predetermined time period, the method comprising:
receiving location information and predetermined time period information, the location information operable for identifying the predetermined geographical area of interest;
processing a respective trending profile associated with each one of a plurality of mobile devices within the telecommunications network to determine, for each one of the plurality of mobile devices, a probability that the mobile device will be in the predetermined geographical area of interest during the predetermined time period; and
if the determined probability of the respective mobile device meets a predetermined probability, the mobile device is identified as one that is likely to be within a predetermined geographical area of interest during the predetermined time period.

11. The method in accordance with claim 10 wherein the identified mobile devices are devices not currently within the predetermined geographical area of interest.

12. The method in accordance with claim 10 further comprising:
performing an action with respect to the identified mobile devices.

13. The method in accordance with claim 12 wherein performing the action further comprises:
supplying information to a messaging system that identifies the identified mobile devices.

14. The method in accordance with claim 10 wherein each trending profile is based on activity information generated in response to one or more activities of the associated mobile device.

15. The method in accordance with claim 14 wherein the activity information for each activity comprises a mobile device identifier, a time period, and position/location information capable of identifying a geographic position/location of the mobile device.

16. A predictive notification processing system for use in identifying (and enabling notification to) mobile devices in a wireless telecommunications network that are likely to be within a predetermined geographical area of interest during a predetermined time period, the predictive processing system comprising:
a processor;
memory coupled to the processor;
a network interface coupled to the processor and operable for communicating with a telecommunications network; and
wherein the processor is operable to:
receive location information associated with an event and predetermined time period information, the location information operable for identifying a predetermined geographical area of interest,
access and examine a trending profile associated with each one of a plurality of mobile devices within a telecommunications network,
determine from the trending profiles, for each one of the plurality of mobile devices, a probability that the mobile device will be in the predetermined geographical area of interest during the predetermined time period, and
generate and store in the memory a list including mobile device identifiers for each mobile device having its determined probability above a predetermined probability threshold.

17. The system in accordance with claim 16 wherein the mobile devices in the list are devices not currently within the predetermined geographical area of interest.

18. The system in accordance with claim 16 wherein the processor is further operable to:
cause a notification message to be sent to each identified mobile device.

19. The system in accordance with claim 10 wherein each trending profile is based on activity information generated in response to one or more activities of the associated mobile device.

20. The system in accordance with claim 19 wherein the activity information for each activity comprises a mobile device identifier, a time period, and position/location information capable of identifying a geographic position/location of the mobile device.
